(19) United States
(12) Patent Application Publication
(10) Pub. No.: US 2021/0064412 A1
(43) Pub. Date: Mar. 4, 2021

(54) CONTAINER IMAGE INTEGRATION SYSTEM, CONTAINER IMAGE INTEGRATION METHOD, AND NON-TRANSITORY COMPUTER-READABLE RECORDING MEDIUM

(71) Applicant: NEC Corporation, Tokyo (JP)

(72) Inventor: Masahiro YAMAGUCHI, Tokyo (JP)

(73) Assignee: NEC Corporation, Tokyo (JP)

(21) Appl. No.: 16/997,200

(22) Filed: Aug. 19, 2020

(30) Foreign Application Priority Data
Aug. 29, 2019 (JP) 2019-156943

(51) Int. Cl. G06F 9/455; G06F 9/445

(52) U.S. Cl. CPC G06F 9/45558; G06F 2009/45562; G06F 9/44505

(57) ABSTRACT

A container image integration system integrates a plurality of layer-by-layer images that are container images of components of a plurality of layers created for the plurality of layers of an integrated image configured by the plurality of layers that is a container image to be created to create the integrated image by copying files from the plurality of layer-by-layer images to the integrated image on the basis of the plurality of layer-by-layer images and configuration definition information of the plurality of layer-by-layer images.

### CROSS REFERENCE TO OTHER APPLICATIONS

This application is based upon and claims the benefit of priority from Japanese patent application No. 2019-156943, filed on Aug. 29, 2019, the disclosure of which is incorporated herein in its entirety by reference.

### BACKGROUND OF THE INVENTION

### Field of the Invention

The present invention relates to a container image integration system, a container image integration method, and a non-transitory computer-readable recording medium.

### Description of Related Art

One of the virtualization techniques is container-type virtualization in which a kernel of an operating system (OS) is shared and a user space is isolated. As a container runtime, for example, Docker by Docker Inc. is known. In container-type virtualization, a file that is obtained by collecting files required for running an application on a container is called a container image or simply an image. Moreover, an apparatus that holds an image of a container is called a container registry or simply a registry. A registry is present locally and on a network. In the case of starting a container from an image that is present in a registry on a network, a container runtime downloads the image from the registry on the network to a local registry and starts the container using the image in the local registry. The image of the container is created using an image definition file. Processes performed on the image serving as a base are described in the image definition file in order of execution. The container runtime sequentially executes the processes described in the image definition file to create the image constructed in layers. A process of each line described in the image definition file corresponds to a layer in the constructed image. When the container is executed, a file in an upper layer is preferentially used. For that reason, in the case of adding a new file or updating a file of any layer, an original image is not changed and a layer configured by a difference file is constructed on the original image, thereby updating the image.

For example, it is assumed that there are two files “/xxx/yyy/zzz-001” and “/xxx/yyy/zzz-002” in a layer 1 of an image as illustrated in FIG. 14. In the case of adding a file “/xxx/yyy/zzz-003”, which is not included in the layer 1, the layer 1 is left as it is, and a layer 2 including only the additional file is constructed on the layer 1, as illustrated in FIG. 15. Further, in the case of changing the file “/xxx/yyy/zzz-002” included in the layer 1, a layer 3 including only a changed file is constructed on the layer 2, as illustrated in FIG. 16. In the case of executing the image configured by these three layers on a container, “/xxx/yyy/zzz-002” in the layer 1 is not used, and the file “/xxx/yyy/zzz-001” in the layer 1, the file “/xxx/yyy/zzz-002” in the layer 3, and the file “/xxx/yyy/zzz-003” in the layer 2 are used, as illustrated in FIG. 17.

Layers can be reused by constructing an image in a layered structure. For example, in the case of changing the file “/xxx/yyy/zzz-001” in the example of FIG. 15, the layer 1 and the layer 2 are reused as they are, and the layer 3′ including only a changed “/xxx/yyy/zzz-001” is added thereon, as illustrated in FIG. 18. Then, an image including “/xxx/yyy/zzz-001” in the layer 3′, “/xxx/yyy/zzz-002” in the layer 1, and “/xxx/yyy/zzz-003” in the layer 2 can be constructed, as illustrated in FIG. 19.

By reusing layers, advantageous effects such as reduction in storage capacity of images, reduction in amount and time of communication at the time of transmitting images, and reduction in construction time at the time of constructing images can be obtained. Layers of an image are constructed in order from the bottom. Thus, in order to improve reusability of the layers, it is necessary to construct the image in order from the bottom from the layer with the lowest update frequency to the layer with the highest update frequency. For that reason, a technique is provided that optimizes the number, capacity and reusability of layers of a generated image by exchanging and/or merging an order of processes at the time of constructing the image. For example, Japanese Unexamined Patent Application, First Publication No. 2019-28690 (hereinafter referred to as “Patent Document 1”) discloses a technique in which processes at the time of constructing an image are classified into categories, and the processes are rearranged such that processes belonging to a category having a higher update frequency are in a higher layer, thereby optimizing the image.

Reuse of layers of an image will be further described. As described above, in container-type virtualization, when an image is updated, a lower layer can be reused by simply adding a new layer including content to be updated on the layers before the update. However, when a lower layer is updated, all layers thereon need to be recreated. For example, in the case of a container configured by an OS, a library, middleware, and an application, an image thereof has layers formed as illustrated in FIG. 20. That is, the bottom layer 1 is a base image of an OS, the second layer 2 from the bottom is an image of a library, the third layer 3 from the bottom is an image of middleware, and the top layer 4 is an image of an application.

In the case of providing the image of the middleware in the example of FIG. 20, an image configured by the layers 1 to 3 is provided. If the base image of the OS in the layer 1 is updated, the image of the middleware must be recreated accordingly. Moreover, there are the following two methods for applying a patch to the middleware while deploying the application on the image of the middleware.

Method 1: A patch to the middleware is applied on the layer 4.

Method 2: A patch to the middleware is applied on the layer 3 and the application is redeployed thereon.

When the patch is applied using the Method 1, the image has the following layered structure.

Layer 5. A layer created by applying a patch to the middleware (top)

Layer 4. A layer created by deploying an application

Layer 3. A layer created by installing middleware

Layer 2. A layer created by installing a library

Layer 1. A base image of an OS (bottom)

For example, when creating an image that includes middleware to which the same patch is applied and a different application, another application has already been deployed in the image configured by the layers 1 to 5 and thus this image cannot be reused as an image of the middleware to which the patch has been applied. Moreover, the files of the middleware in the middle layer 3 include files that are no longer needed due to the application of the patch to the middleware in a layer 5, and thus the size of the image unnecessarily increases. Further, for example, if application of a patch to the middleware and update of an application are repeated using the Method 1, layers for applying patches to the middleware and layers for updating the application alternately overlap each other, which makes reuse of the image of the middleware difficult.

When the patch is applied using the Method 2, the image has the following layered structure. The layers up to the middleware configured by the layers 1 to 4 can be reused when a different application is deployed.

Layer 5. A layer created by deploying an application (top)

Layer 4. A layer created by applying a patch to middleware

Layer 3. A layer created by installing middleware

Layer 2. A layer created by installing a library

Layer 1. A base image of an OS (bottom)

However, since the layers of the image need to be constructed in order from the bottom, the image in which the application is deployed needs to be recreated each time a patch is applied to the middleware. That is, reinstallation of the OS, the library, the middleware, the patch, and the application is necessary.

Further, according to the method described in Patent Document 1, when application of a patch to the middleware and update of the application are repeated, the image is constructed in accordance with the update frequency thereof, but the update frequency often varies in each of a development phase and an operation phase. For example, during development of an application, an update frequency of an execution environment of the application, such as middleware, is low and the update frequency of the application is high. During operation, since there is no change in the application, application of the patch to the execution environment and the like may occur, and thus the update frequency may be opposite to that during development. For that reason, it is necessary to recreate an optimized image each time the update frequency of each layer changes.

### SUMMARY OF THE INVENTION

There is a demand for a method for creating an image of an execution environment for an application while ensuring reusability of an image of each component that constitutes the application.

Therefore, an example object of the present invention is to provide a container image integration system, a container image integration method, and a non-transitory computer-readable recording medium that solve the above problems.

An example aspect of the present invention is a container image integration system that includes: a memory configured to store instructions; and a processor configured to execute the instructions to integrate a plurality of layer-by-layer images that are container images of components of a plurality of layers created for the plurality of layers of an integrated image configured by the plurality of layers that is a container image to be created to create the integrated image by copying files from the plurality of layer-by-layer images to the integrated image on the basis of the plurality of layer-by-layer images and configuration definition information of the plurality of layer-by-layer images.

Moreover, an example aspect of the present invention is a container image integration method that includes integrating a plurality of layer-by-layer images that are container images of components of a plurality of layers created for the plurality of layers of an integrated image configured by the plurality of layers that is a container image to be created to create the integrated image by copying files from the plurality of layer-by-layer images to the integrated image on the basis of the plurality of layer-by-layer images and configuration definition information of the plurality of layer-by-layer images.

Furthermore, an example aspect of the present invention is a non-transitory computer-readable recording medium that stores a program causing a computer to execute a process of integrating a plurality of layer-by-layer images that are container images of components of a plurality of layers created for the plurality of layers of an integrated image configured by the plurality of layers that is a container image to be created to create the integrated image by copying files from the plurality of layer-by-layer images to the integrated image on the basis of the plurality of layer-by-layer images and configuration definition information of the plurality of layer-by-layer images.

According to the present invention, a target container image can be created by integrating a plurality of container images in container-type virtualization.

### BRIEF DESCRIPTION OF THE DRAWINGS

FIG. 1 is a diagram showing an example of a container image integration system in accordance with an example embodiment of the present invention.

FIG. 2 is a first schematic diagram showing an image integration process in accordance with the example embodiment of the present invention.

FIG. 3 is a second schematic diagram showing the image integration process in accordance with the example embodiment of the present invention.

FIG. 4 is a third schematic diagram showing the image integration process in accordance with the example embodiment of the present invention.

FIG. 5 is a fourth schematic diagram showing the image integration process in accordance with the example embodiment of the present invention.

FIG. 6 is a first diagram showing an example of configuration definition information of a component image in accordance with the example embodiment of the present invention.

FIG. 7 is a second diagram showing an example of the configuration definition information of the component image in accordance with the example embodiment of the present invention.

FIG. 8 is a diagram showing an example of integration definition information in accordance with the example embodiment of the present invention.

FIG. 9 is a diagram showing an example of a creation process of a component image in accordance with the example embodiment of the present invention.

FIG. 10 is a first diagram showing an example of an image integration process in accordance with the example embodiment of the present invention.

FIG. 11 is a second diagram showing an example of the image integration process in accordance with the example embodiment of the present invention.

FIG. 12 is a third diagram showing an example of the image integration process in accordance with the example embodiment of the present invention.

FIG. 13 is a fourth diagram showing an example of the image integration process in accordance with the example embodiment of the present invention.

FIG. 14 is a first diagram that describes updating of a layered image.

FIG. 15 is a second diagram that describes updating of a layered image.

FIG. 16 is a third diagram that describes updating of a layered image.

FIG. 17 is a fourth diagram that describes updating of a layered image.

FIG. 18 is a fifth diagram that describes updating of a layered image.

FIG. 19 is a sixth diagram that describes updating of a layered image.

FIG. 20 is a diagram showing an example of a layer configuration in container-type virtualization.

FIG. 21 is a diagram showing a minimum configuration of the container image integration system in the example embodiment of the present invention.

FIG. 22 is a diagram showing an example of a hardware configuration of the container image integration system in the example embodiment of the present invention.

### DETAILED DESCRIPTION OF THE INVENTION

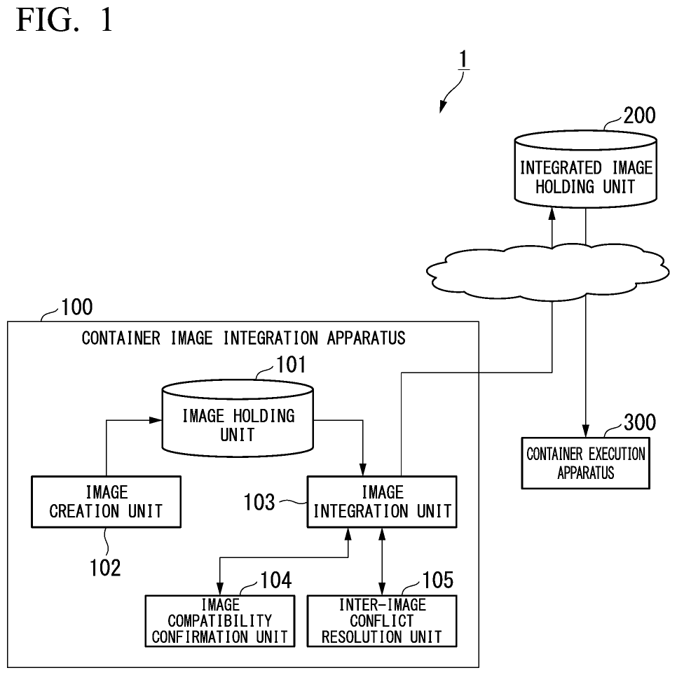

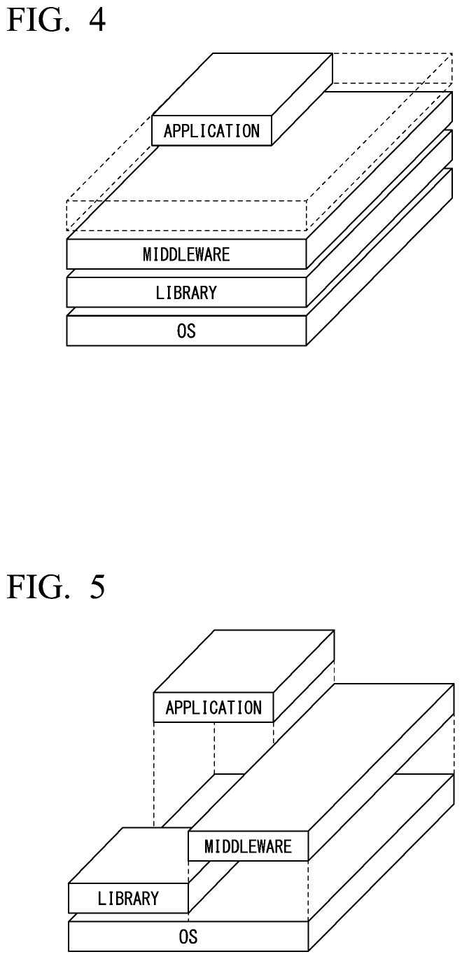

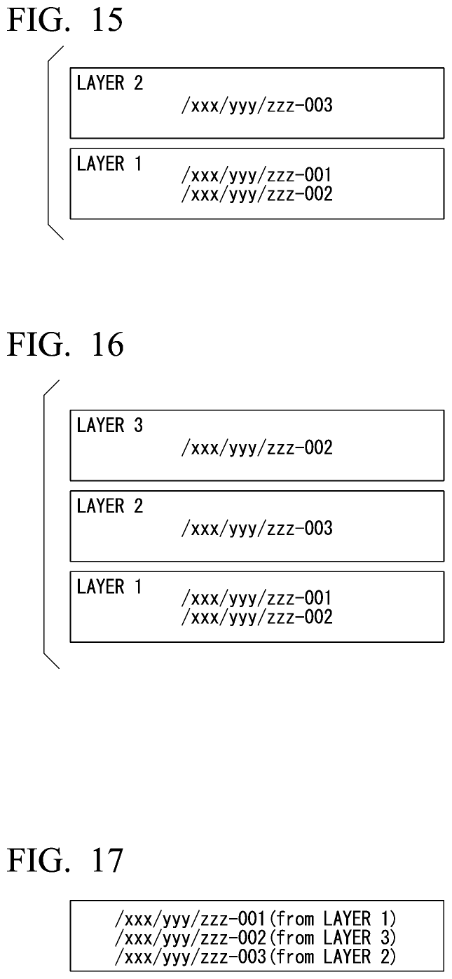

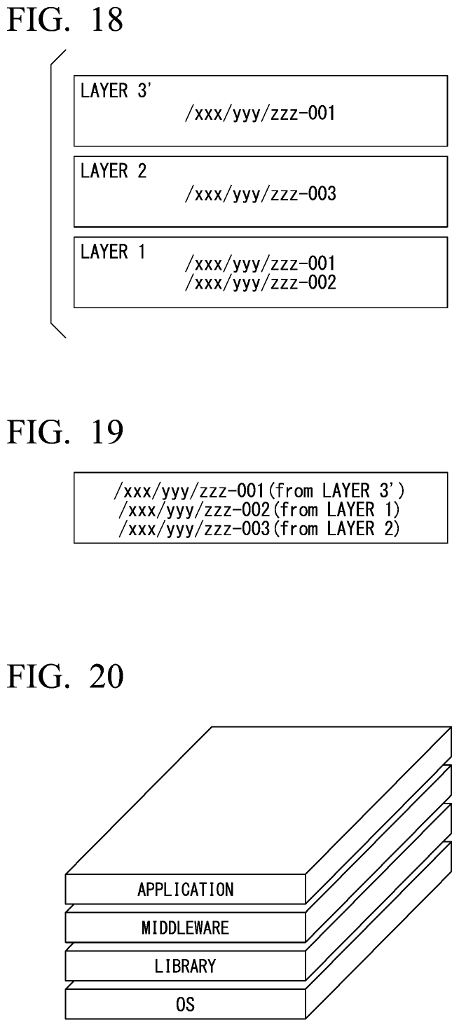

Hereinafter, a container image integration system in accordance with an example embodiment will be described with reference to FIGS. 1 to 22.

### Configuration of Container Image Integration System

FIG. 1 is a diagram showing an example of the container image integration system in accordance with the example embodiment of the present invention.

As shown in FIG. 1, a container image integration system 1 includes a container image integration apparatus 100, an integrated image holding unit 200, and a container execution apparatus 300. The container image integration apparatus 100 and the integrated image holding unit 200 are connected to each other via a network. The integrated image holding unit 200 and the container execution apparatus 300 are connected to each other via the network.

The container image integration apparatus 100 creates an image of a container to be executed by the container execution apparatus 300 using an integration process, which will be described later. The image created by the integration process is called an integrated image. The container image integration apparatus 100 stores the created integrated image in the integrated image holding unit 200. The integrated image holding unit 200 is a storage apparatus. The integrated image holding unit 200 holds the integrated image created by the container image integration apparatus 100. A container runtime is operated in the container execution apparatus 300. The container execution apparatus 300 downloads an integrated image to be executed from the integrated image holding unit 200 and starts the container based on the integrated image. An application runs on the container. The integrated image holding unit 200 has the same configuration as a general container registry. The container execution apparatus 300 has the same configuration as a general container runtime.

The container image integration apparatus 100 includes an image holding unit 101, an image creation unit 102, an image integration unit 103, an image compatibility confirmation unit 104, and an inter-image conflict resolution unit 105.

The image holding unit 101 holds an image of each component that constitutes an application operated on the container based on the integrated image. A component is software corresponding to each layer of the integrated image. The image of each component is called a component image or a layer-by-layer image. For example, when an OS (the layer 1), a library (the layer 2), middleware (the layer 3), and an application (the layer 4) are required to be installed to operate the application (the layer 4) on the container, components constituting the application (the layer 4) are the OS (the layer 1), the library (the layer 2), the middleware (the layer 3), and the application (the layer 4). Moreover, component images of the components are a component image of the OS (the layer 1), a component image of the library (the layer 2), a component image of the middleware (the layer 3), and a component image of the application (the layer 4). The component image of the OS (the layer 1) is a base image in which the OS (the layer 1) is installed. The component image of the library (the layer 2) is an image created by installing the OS (the layer 1) and the library (the layer 2) in that order. The component image of the middleware (the layer 3) is an image created by installing the OS (the layer 1), the library (the layer 2), and the middleware (the layer 3) in that order. The component image of the application (the layer 4) is an image created by installing the OS (the layer 1), the library (the layer 2), the middleware (the layer 3), and the application (the layer 4) in that order. In the present example embodiment, in order to create an integrated image in which the application (the layer 4) operates, independent component images of these four layers (the layers 1 to 4) are created and each component image is managed individually.

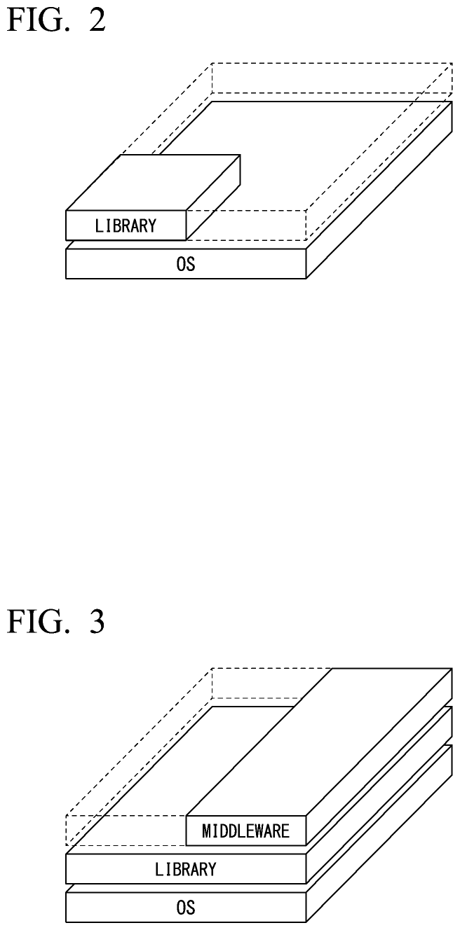

Further, as long as the locations of files included in each component image are independent from each other, it is possible to create an integrated image by updating the component image of each layer individually, extracting only necessary files from each component image, and copying the extracted files to a container image to be created. This situation is shown in FIGS. 2 to 4. FIGS. 2 to 4 show component images of layers 2 to 4, respectively. The range defined by solid lines in the top layer of each component image represents files necessary for an integrated image. By extracting and combining only these files, the integrated image having a smaller size than that illustrated in FIG. 20 can be created as illustrated in FIG. 5.

However, when the necessary files are copied to the integrated image, it is necessary to confirm that compatibility between the components is secured, and when the locations of the files of the components are not completely independent from each other, it is necessary to determine a solution for conflict between files. Therefore, in the present example embodiment, the locations of the files that are included in the component image and are necessary for the integrated image, version information of another component in another layer (e.g., a lower layer) on which a component depends, and a solution for a case in which files conflict with each other are defined for each component in configuration definition information of the component images, which will be described later, and checking is performed on the basis of these definitions.

The image holding unit 101 holds the configuration definition information of the component images. The configuration definition information includes the following information.

(1) name: The image name of a component image

(2) version: The version of a component included in the component image

(3) depends: The image name and the compatible version range of the dependent component

(4) includes: The locations of files that are included in the component image and are copied to the integrated image

(5) excludes: The locations of files that are included in the component image and are excluded from the files specified in the “includes” (files that are not copied to the integrated image)

(6) resolver: A solution when there is a conflict with a file included in the image of the dependent component (such as overwriting, not copying, merging content)

(7) after-script: A process executed after image integration

Among the above, the “name”, the “version”, and the “includes” are necessary information, and the others are optional information.

The configuration definition information may be held in the image holding unit 101 as a table T100, for which a set of the “name” and the “version” is used as a key. Alternatively, the configuration definition information may be held as metadata of the component image itself and may be stored in the image holding unit 101.

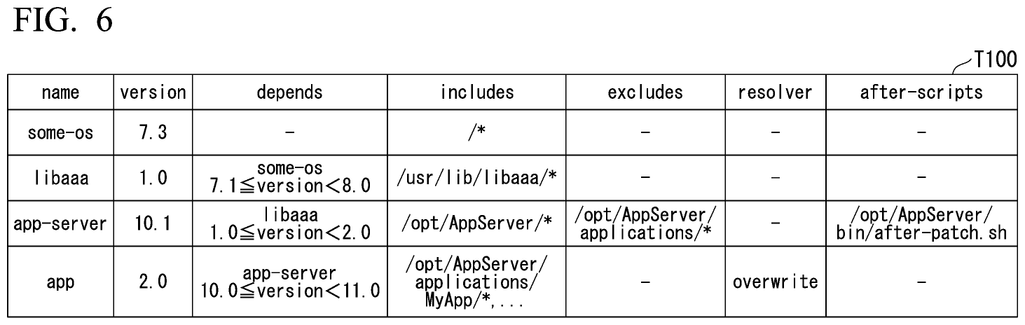

The table T100 is searched using a set of the “name” and the “version” as a key and the table T100 has columns of the “depends”, the “includes”, the “excludes”, the “resolver”, and the “after-script”. FIG. 6 illustrates the table T100.

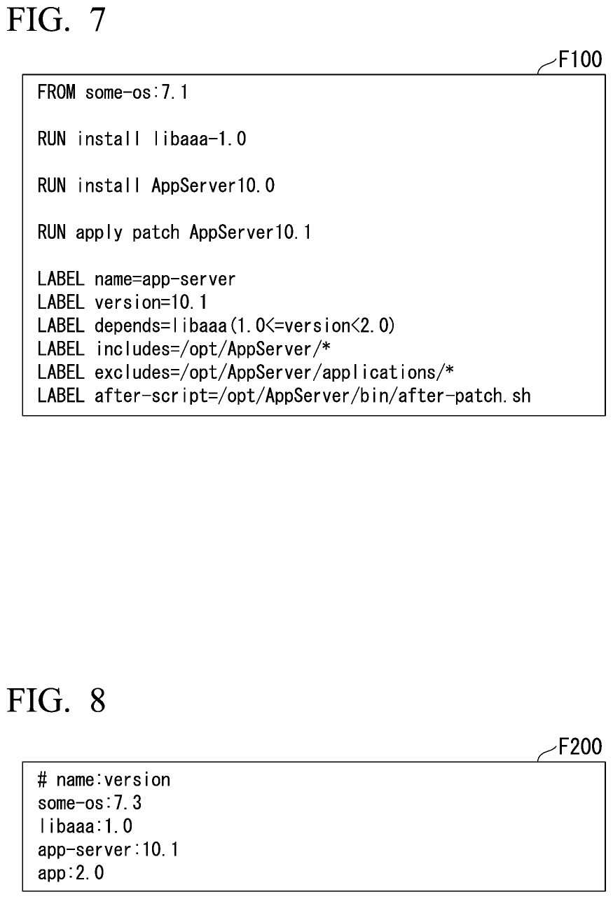

When the configuration definition information is held as metadata, the configuration definition information is described in an image definition file F100 used for creation of an image. In the case of Docker, the image definition file F100 is a Dockerfile. In the Dockerfile, the metadata can be held in the image using LABEL commands. FIG. 7 illustrates an example of the image definition file F100.

When the integrated image is configured by four components including an OS (the layer 1), a library (the layer 2), a middleware (the layer 3), and an application (the layer 4), the configuration definition information of each component image is as follows, for example.

Component image of OS (layer 1)

name: some-os

version: 7.3

includes: /*

Component image of library (layer 2)

name: libaaa

version: 1.0

depends: some-os (7.1≤version<8.0)

includes: /usr/lib/libaaa/*

Component image of middleware (layer 3)

name: app-server

version: 10.1

depends: libaaa (1.0≤version<2.0)

includes: /opt/AppServer/*

excludes: /opt/AppServer/applications/*

after-script: /opt/AppServer/bin/after-patch.sh

Component image of application (layer 4)

name: app

version: 2.0

depends: app-server (10.0≤version<11.0)

includes: /opt/AppServer/applications/MyApp/*, /opt/AppServer/config.xml

resolver: overwrite

When the configuration definition information is held in the image itself, the image holding unit 101 has the same configuration as a general container registry. When the configuration definition information is held separately from the image, the image holding unit 101 further holds the table T100 in addition to the general container registry.

The image creation unit 102 creates the component image of each component that constitutes the application operated on the container on the basis of the image definition file F100 and stores the component image in the image holding unit 101. Moreover, the image creation unit 102 updates each component image to be in the latest state by, for example, applying a patch to each component image. The image creation unit 102 stores each updated component image in the image holding unit 101.

The image integration unit 103 acquires the component image of each component that constitutes the application (the layer 4) operated on the container from the image holding unit 101 on the basis of an integrated image definition file F200 (integration definition information) and performs an integration process of integrating the component images to create the integrated image. The image integration unit 103 stores the created integrated image in the integrated image holding unit 200. The integration process is a process of extracting necessary files from the component image of each layer and copying the extracted files to the same locations in the integrated image. This is different from a method for creating a final image by sequentially installing the library (the layer 2), the middleware (the layer 3), and the application (the layer 4) on the image of the OS (the layer 1) as in a general process of creating an image.

The integrated image definition file F200 is a file in which sets of the “name” and the “version” of the component images necessary for creating the integrated image are described in the order in which the integration process is performed. The images are integrated (the files are copied) in the order described therein. FIG. 8 illustrates an example of the integrated image definition file F200. The integrated image definition file F200 may be included in the image integration unit 103, for example. Alternatively, the integrated image definition file F200 may be stored in a storage unit (not shown) of the container image integration apparatus 100.

The image integration unit 103 uses the image compatibility confirmation unit 104 to confirm compatibility between the images at the time of an image integration process. Moreover, the image integration unit 103 uses the inter-image conflict resolution unit 105 to resolve file conflicts between the images at the time of the image integration process.

The image compatibility confirmation unit 104 confirms the compatibility between the images on the basis of compatibility information (version information) of the component images. The image compatibility confirmation unit 104 confirms, for example, whether or not component images of the OS (the layer 1), the library (the layer 2), and the middleware (the layer 3) having versions suitable for the application (the layer 4) are selected as copy sources of the files in the integration process.

The inter-image conflict resolution unit 105 resolves file conflicts between the images on the basis of information on the locations (path information) of the files of the component image and information on a method for resolving a conflict (the value of the “resolver”, which will be described later). For example, when the integrated image definition file F200 describes that the library (the layer 2) and the middleware (the layer 3) are processed in that order and a file path of the library (the layer 2) and a file path of the middleware (the layer 3) coincide (compete) with each other, and when “overwrite” is set in the information on the method for resolving a conflict, the inter-image conflict resolution unit 105 overwrites content of a file included in the component image of the library (the layer 2) with content of a file included in the component image of the middleware (the layer 3).

Next, an operation of the container image integration system 1 will be described. Hereinafter, a case in which the integrated image including the OS (the layer 1), the library (the layer 2), the middleware (the layer 3), and the application (the layer 4) in order from the bottom is created will be described as an example. Moreover, it is assumed that the image definition file F100 and the integrated image definition file F200 are prepared in advance at predetermined positions.

### Creation Process of Component Images

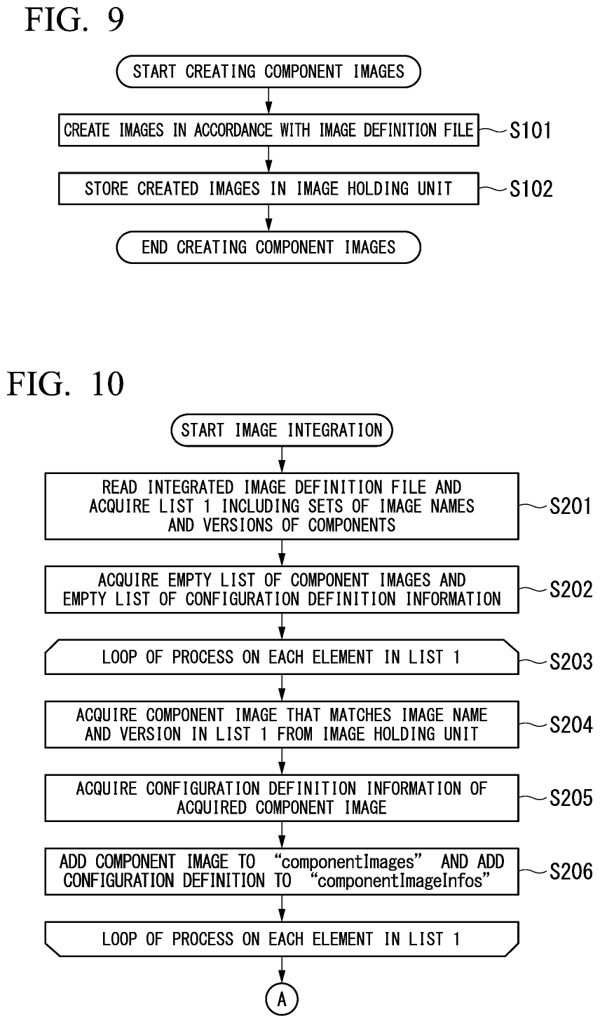

First, a creation process of component images will be described with reference to FIG. 9.

FIG. 9 is a diagram showing an example of a creation process of component images in accordance with the example embodiment of the present invention.

First, the image creation unit 102 creates images on the basis of the image definition file F100 (step S101). The image definition file F100 and a creation process of the image based on the image definition file F100 are the same as those of a general container runtime. For example, the image creation unit 102 creates a component image of the middleware (the layer 3) (AppServer 10.1) on the basis of the image definition file F100 illustrated in FIG. 7. Similarly, the image creation unit 102 creates component images of the other layers 1, 2, and 4.

It should be noted that when the image of each component is created, the component of each image for the lower layers other than the top layer does not necessarily need to have a version required for an integrated image and needs only be compatible with the version of an integration target. For example, with respect to the component image of the layer 4, an integrated image in which the application (the layer 4) is deployed on the middleware (the layer 3) of version “10.1” can be created by deploying the application (the layer 4) on the component image of the middleware (the layer 3) of version “10.0” to create the image of the application and then, at the time of the integration process, integrating the component image in which the middleware (the layer 3) of version “10.1” is installed.

Next, the image creation unit 102 stores the created component images in the image holding unit 101 (step S102). It should be noted that when the configuration definition information is held in the table T100, information such as the “name” and the “version” of each component is registered in the table T100. When the configuration definition information is described in the image definition file F100, the component image created on the basis of the image definition file F100 holds the information as metadata, and thus no additional process is required.

### Creation Process of Integrated Image: Integration Process

Next, a flow of the integration process will be described with reference to FIGS. 10 to 13.

FIGS. 10 to 13 are respectively first to fourth diagrams showing an example of an image integration process in accordance with the example embodiment of the present invention.

First, FIG. 10 will be referred to. The image integration unit 103 reads the integrated image definition file F200 and acquires a list “componentNames” (a list 1) including a set of an image name (“name”) and a version (“version”) of each component (step S201). Each element of the “componentNames” is referred to as a “componentName”.

Next, the image integration unit 103 acquires, as an initial state, an empty list for the component images “componentImages” and an empty list for the configuration definition information “componentImageInfos” (step S202).

Next, the image integration unit 103 repeats the following processes of Steps S204 to S206 for each element (“componentName”) of the “componentNames” (the list 1) (step S203).

The image integration unit 103 acquires, from the image holding unit 101, a component image that matches the image name (“name”) and the version (“version”) of the “componentName” (step S204). The image integration unit 103 sets the acquired component image in a “componentImage” object.

Next, the image integration unit 103 selects a set of information including the “depends,” the “includes,” the “excludes,” the “resolver,” and the “after-script” from metadata of the acquired component image or from the configuration definition information of the table T100 in the image holding unit 101 (step S205). The image integration unit 103 sets the acquired set of information in a “componentImageInfo” object.

Next, the image integration unit 103 adds the “componentImage” to the “componentImages” and adds the “componentImageInfo” to the “componentImageInfos” (step S206).

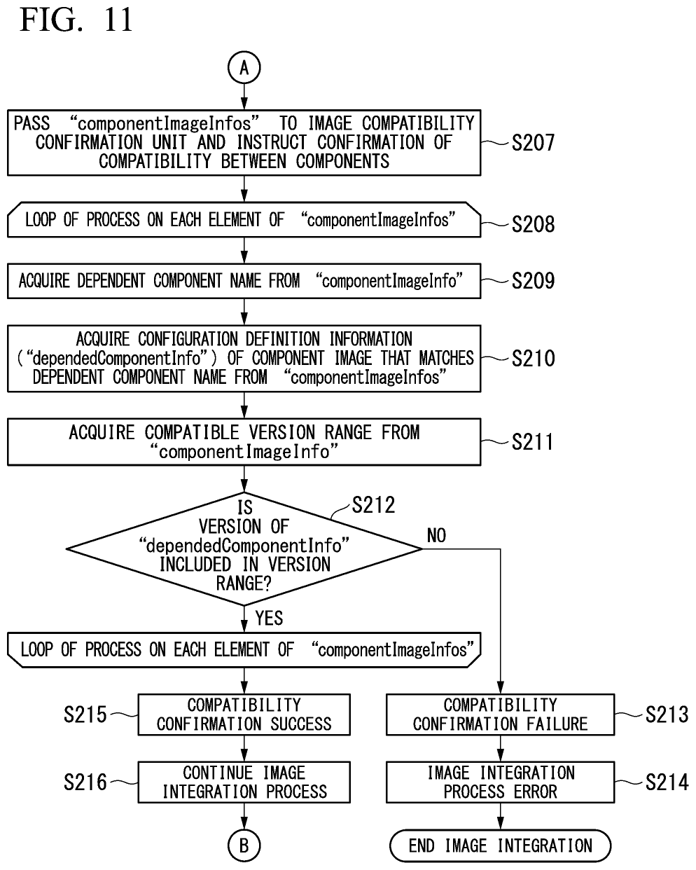

Subsequently, FIG. 11 will be referred to. The image integration unit 103 passes the “componentImageInfos” to the image compatibility confirmation unit 104 and instructs confirmation of compatibility between components (step S207).

The image compatibility confirmation unit 104 repeats the following processes of steps S209 to S214 for each element of the “componentImageInfos” (step S208). An element of the “componentImageInfos” in the repetition is referred to as a “componentImageInfo”.

The image compatibility confirmation unit 104 acquires a dependent component name “dependedComponentName” from the “depends” of the “componentImageInfo” (step S209). For example, the image compatibility confirmation unit 104 acquires “some-os” from the “depends” of the library (the layer 2) as the “dependedComponentName”.

Next, the image compatibility confirmation unit 104 acquires a “componentImageInfo” (which is referred to as a “dependedComponentInfo”) of the component image which matches the component name “dependedComponentName” from the “componentImageInfos” (step S210). For example, the image compatibility confirmation unit 104 acquires the “componentImageInfo” of the “some-os” from the “componentImageInfos” and sets the acquired “componentImageInfo” in a “dependedComponentInfo” object.

Next, the image compatibility confirmation unit 104 acquires a compatible version range “VersionRange” from the “depends” of the “componentImageInfo” acquired in step S209 and sets the acquired compatible version range “VersionRange” as a “compatibleVersionRange” (step S211). For example, the image compatibility confirmation unit 104 acquires a version range “(7.1≤version<8.0)” of the “some-os” from the “depends” of the library (the layer 2) and sets the version range in a “compatibleVersionRange” object.

Next, the image compatibility confirmation unit 104 confirms whether or not the version of the “dependedComponentInfo” is included in the range of the “compatibleVersionRange” (step S212). For example, in the above example, the image compatibility confirmation unit 104 determines whether a version “7.3” of the “some-os” is included in “(7.1≤version<8.0)” or not.

When the version of the “dependedComponentInfo” is not included in the range of the “compatibleVersionRange” (step S212; No), the image compatibility confirmation unit 104 returns a result indicating confirmation failure to the image integration unit 103 (step S213). The image integration unit 103 regards the result of the process as an image integration process error and ends the integration process (step S214).

When the version of the “dependedComponentInfo” is included in the range of the “compatibleVersionRange” (step S212; Yes), the image compatibility confirmation unit 104 continues the loop process and confirms compatibility of the other component images as well.

When the compatibility confirmation of all layers is successful, the image compatibility confirmation unit 104 returns a result indicating confirmation success to the image integration unit 103 (step S215). The image integration unit 103 continues the integration process (step S216).

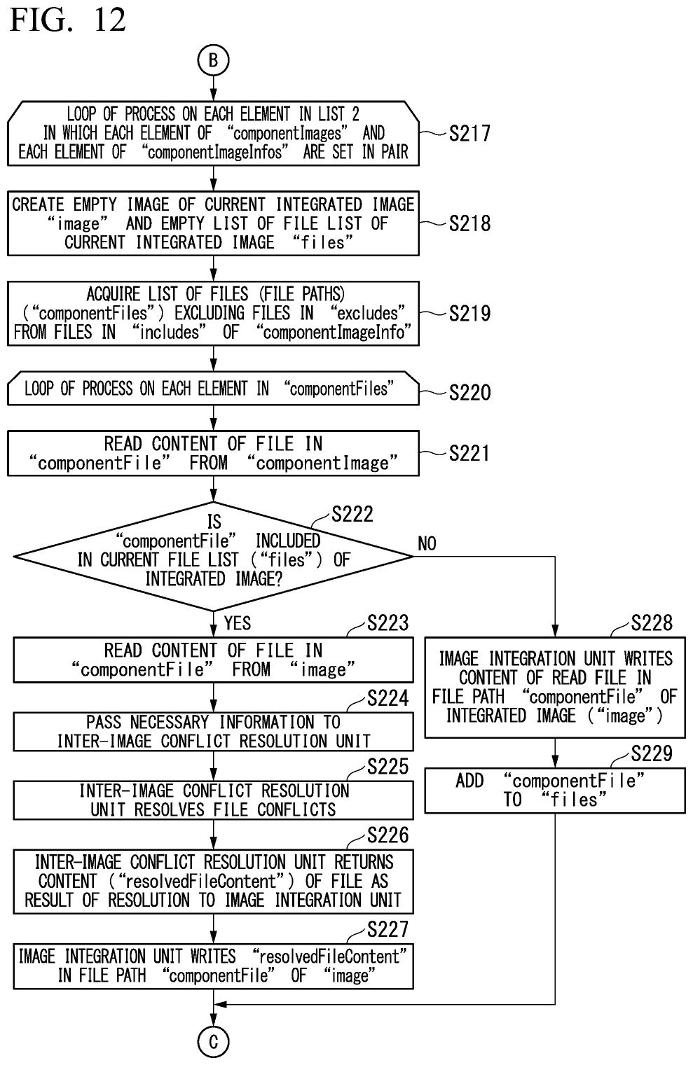

Subsequently, FIG. 12 will be referred to. Next, the image integration unit 103 repeats the following processes of steps S218 to S229 for each element of a list 2 in which an element of the “componentImages” and an element of the “componentImageInfos” created in step S206 of FIG. 10 are set in pair (step S217). In the repetition, an element of the “componentImages” is referred to as a “componentImage” and an element of the “componentImageInfos” is referred to as a “componentImageInfo”.

As an initial state, the image integration unit 103 creates an empty image for the current integrated image “image” and an empty list for a list of files of the current integrated image “files” (step S218).

Next, the image integration unit 103 acquires a list of files (file paths) excluding files in the “excludes” from files in the “includes” of the “componentImageInfo” (step S219). These files are referred to as “componentFiles”.

Next, the image integration unit 103 repeats the following processes of steps S221 to S229 for each element of the “componentFiles” (step S220). An element of the “componentFiles” in the repetition is referred to as a “componentFile”.

The image integration unit 103 reads content of a file in the “componentFile” from the “componentImage” and sets the content in a “componentFileContent” object (step S221).

The image integration unit 103 confirms whether the “componentFile” is included in the “files” or not (step S222).

If the “componentFile” is included in the “files” (step S222; Yes), the image integration unit 103 reads the content of the file in the “componentFile” from the “image” and sets the read content in a “fileContent” object (step S223). Next, the image integration unit 103 passes various pieces of information necessary to resolve file conflicts, such as information on the “componentFile” (path information of a file of a copy source), the “fileContent” (content of a file already existing in the integrated image), the “componentFileContent” (content of the file of the copy source), and the “resolver” of the “componentImageInfo” to the inter-image conflict resolution unit 105 (step S224).

Next, the inter-image conflict resolution unit 105 resolves the file conflicts on the basis of the value of the “resolver” (step S225). For example, if the value of the “resolver” is “overwrite”, the inter-image conflict resolution unit 105 overwrites the “fileContent” with the “componentFileContent”. For example, if the value of the “resolver” is a value indicating that the content of “fileContent” existing in the current integrated image has priority, the inter-image conflict resolution unit 105 gives priority to the “fileContent” and discards the “componentFileContent”. For example, if the value of “resolver” is a value indicating that the content of the “fileContent” and the “componentFileContent” are to be merged, the inter-image conflict resolution unit 105 adds the “componentFileContent” to the “fileContent”.

If the value of the “resolver” does not exist, a default operation is performed. For example, as the default operation, the process may end because of resolution failure. The inter-image conflict resolution unit 105 sets the content of the file after the conflicts have been resolved in a “resolvedFileContent” object.

Next, the inter-image conflict resolution unit 105 returns the “resolvedFileContent” to the image integration unit 103 (step S226).

The image integration unit 103 writes the content of the “resolvedFileContent” in the file path “componentFile” of the “image” (step S227).

If the “componentFile” is not included in the “files” (step S222; No), the image integration unit 103 writes the content of the “componentFileContent” in the file path “componentFile” of the “image” (step S228). The image integration unit 103 adds the “componentFile” to the list “files” (step S229).

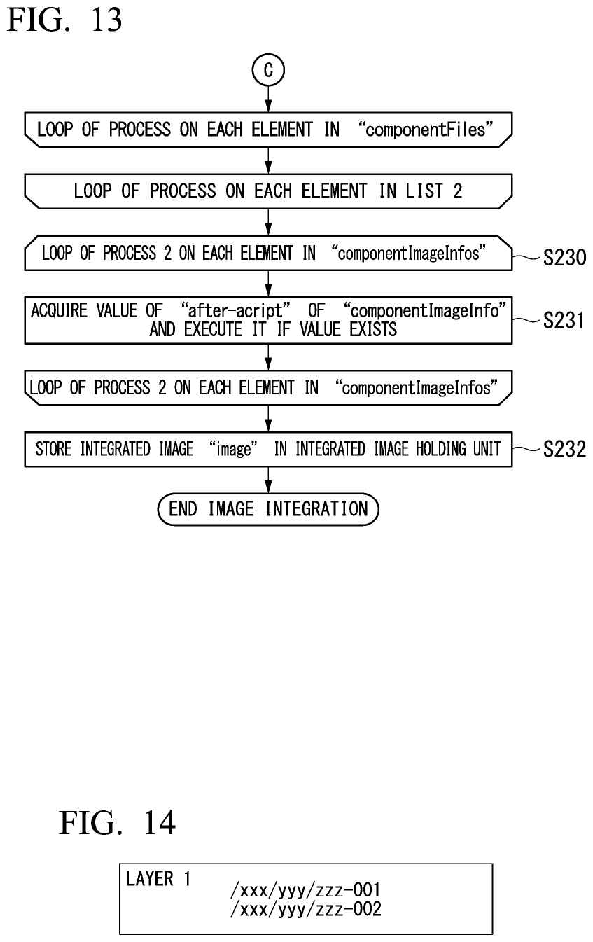

Subsequently, FIG. 13 will be referred to. When the loop processes of steps S217 and S220 are completed, the image integration unit 103 then repeats the following process of step S231 (a process 2) for each element of the “componentImageInfos” (step S230). An element of the “componentImageInfos” in the repetition is referred to as a “componentImageInfo”.

The image integration unit 103 acquires the value of the “after-script” of the “componentImageInfo”, and if the value exists, executes a process written in the “after-script” for the “image” and updates the “image” (step S231).

Finally, the image integration unit 103 stores the integrated image “image” in the integrated image holding unit 200 (step S232). Thus, the integrated image is created by copying the necessary files from the component images of each layer.

According to the present example embodiment, when creating an image of container-type virtualization, a component image is created for each layer that constitutes an image to be created (integrated image) and is managed individually. In addition, the image integration unit 103 uses the component images and the file path information set in the table T100 to perform the integration process of the component images. When file conflicts occur between the component images, the inter-image conflict resolution unit 105 resolves the conflict state. Further, the image compatibility confirmation unit 104 confirms the compatibility between the component images to determine whether or not the integration is possible. With these configurations, it is possible to create the image of the execution environment of the application (integrated image) while ensuring reusability of the image of each component that constitutes the image to be created.

According to the present example embodiment, the component image is created for each layer and the image integration unit 103 copies necessary files for the component from each component image to create the integrated image, and thus each component image can be maintained as an independent file and updated individually. For example, when a patch is applied to the middleware (the layer 3), a labor of recreating an image (redoing the installation) as in the Method 1 and the Method 2 described as general methods for applying a patch to a container image can be omitted, and a component image that reflects the latest state of the middleware (the layer 3) can be managed by only performing a patch application process for the component image of the middleware (the layer 3). Moreover, since the component image is created for each component, it is easy to reuse the component image.

Moreover, with the configuration of copying the necessary files from each component image to the integrated image, it is not necessary to match the version of a lower component on which a component in each component image depends with the version at the time of integration, and a lower component may be arbitrarily selected within the range of a compatible version.

Further, files that are no longer needed due to application of a patch or the like and intermediate layers created by the application of a patch are accumulated in each component image. However, since only the necessary files are copied to the integrated image, there are no unnecessary files left in the integrated image, and thus the size of the integrated image can be kept small.

Although the container image integration apparatus 100 in the above example embodiment has the image holding unit 101 and the image creation unit 102, the image holding unit 101 and the image creation unit 102 may be provided in another apparatus that is independent of the container image integration apparatus 100. In the case of this configuration, the container image integration apparatus 100 and another apparatus are connected to each other via a network.

Further, when the conflicts during the image integration process are always resolved by overwriting, the inter-image conflict resolution unit 105 is not necessary. In the case of this configuration, only steps S228 and S229 among the processes of steps S222 to S229 in FIG. 12 are provided.

It should be noted that when a patch is applied to the middleware (the layer 3) after the integrated image is created using the integration process of the present example embodiment, the image creation unit 102 performs a patch application process on the component image of the middleware (the layer 3). In addition, the image integration unit 103 uses the component images of the layers 1 to 4 (the layer 3 is the component image after the patch has been applied) to perform the processes in FIGS. 10 to 13 again to recreate the integrated image. With such a process, it is not necessary to recreate the integrated image by reinstallation, and thus a management cost of the integrated image can be reduced as compared with the processes of the Method 1 and the Method 2.

Moreover, with the Method 1 and the Method 2, it is necessary to set each setting file and the like for recreating an image again. In contrast, in the present example embodiment, it is possible to further reduce a processing cost for recreating the integrated image when application of a patch or the like occurs by reflecting setting content of the integrated image in each of the component images of the layers 1 to 4 and the like.

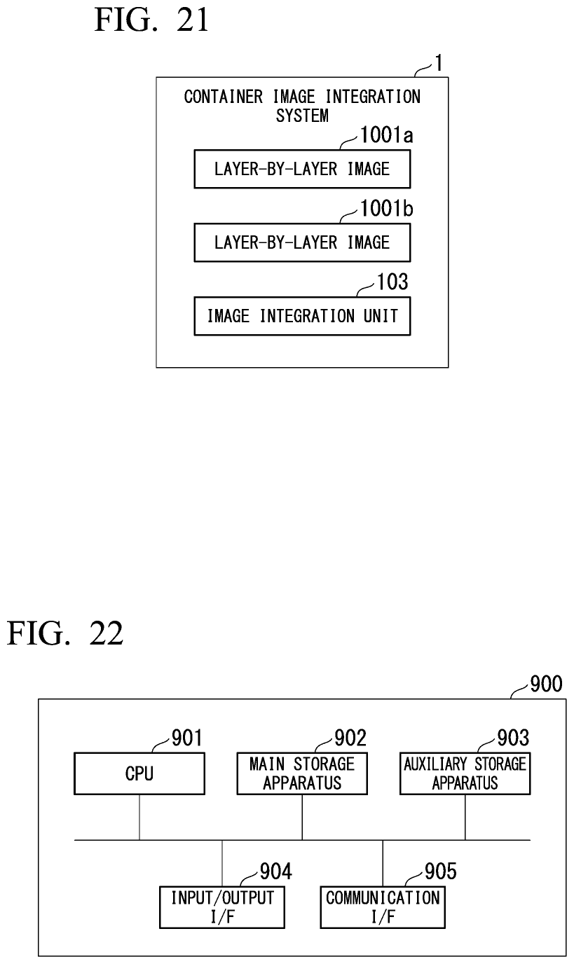

FIG. 21 is a diagram showing a minimum configuration of the container image integration system in the example embodiment of the present invention.

As shown in FIG. 21, the container image integration system 1 has at least a plurality of layer-by-layer images 1001a and 1001b and the image integration unit 103.

The layer-by-layer images 1001a and 1001b are container images of the components of a plurality of layers created for the plurality of layers of the integrated image, which is a container image to be created and is configured by the plurality of layers. The layer-by-layer images 1001a and 1001b shown in FIG. 21 are examples, and the container image integration system 1 may have three or more layer-by-layer images.

The image integration unit 103 copies files from the layer-by-layer images 1001a and 1001b to the container image to be created on the basis of the configuration definition information (illustrated in FIGS. 6 and 7) of the layer-by-layer images 1001a and 1001b to create the integrated image in which the layer-by-layer images 1001a and 1001b are integrated together.

FIG. 22 is a diagram showing an example of a hardware configuration of the container image integration system in the example embodiment of the present invention.

A computer 900 includes a central processing unit (CPU) 901, a main storage apparatus 902, an auxiliary storage apparatus 903, an input/output interface 904, and a communication interface 905. The container image integration apparatus 100 is installed in the computer 900. In addition, an operation of each functional unit described above is stored in the auxiliary storage apparatus 903 in the form of a program. The CPU 901 reads the program from the auxiliary storage apparatus 903, loads the program in the main storage apparatus 902, and executes the above processes in accordance with the program. Moreover, the CPU 901 secures a storage region in the main storage apparatus 902 in accordance with the program. Further, the CPU 901 secures a storage region for storing data being processed in the auxiliary storage apparatus 903 in accordance with the program.

It should be noted that in at least one example embodiment, the auxiliary storage apparatus 903 is an example of a non-transitory tangible medium. Other examples of non-transitory tangible media include magnetic disks, magneto-optical discs, compact disc read only memories (CD-ROMs), digital versatile disc (DVD)-ROMs, semiconductor memories, and the like, which are connected via the input/output interface 904. Moreover, when the program is distributed to the computer 900 via a communication line, the computer 900 that has received the distribution may load the program into the main storage apparatus 902 and execute the above processes. Further, the program may be a program for realizing some of the functions described above. In addition, the program may be a so-called difference file (difference program) that realizes the functions described above in combination with another program already stored in the auxiliary storage apparatus 903.

Besides, it is possible to appropriately replace the constituent elements in the example embodiments described above with known constituent elements without departing from the gist of the present invention. In addition, the technical scope of the present invention is not limited to the example embodiments described above, and various modifications can be made without departing from the gist of the present invention.

What is claimed is:

1. A container image integration system comprising:
a memory configured to store instructions; and
a processor configured to execute the instructions to integrate a plurality of layer-by-layer images that are container images of components of a plurality of layers created for the plurality of layers of an integrated image configured by the plurality of layers that is a container image to be created to create the integrated image by copying files from the plurality of layer-by-layer images to the integrated image on the basis of the plurality of layer-by-layer images and configuration definition information of the plurality of layer-by-layer images.

2. The container image integration system according to claim 1 wherein the processor is configured to execute the instructions to confirm compatibility between a components of a layer and a component of another layer on which the component depends.

3. The container image integration system according to claim 1 wherein the processor is configured to execute the instructions to resolve a conflict of a file on the basis of the configuration definition information in a case of a conflict state in which the file already exists in a copy destination.

4. The container image integration system according to claim 1, wherein the memory is configured to store the plurality of layer-by-layer images, and
when the integrated image is configured by N layers, N being an integer greater than or equal to 2, the memory is configured to store N layer-by-layer images, and a layer-by-layer image of an n-th layer from the bottom, n being an integer that satisfies 1≤n≤N, is a container image including a component corresponding to a first layer from the bottom to a component corresponding to the n-th layer from the bottom.

5. The container image integration system according to claim 4 wherein the processor is configured to execute the instructions to create and update the plurality of layer-by-layer images, and when a component corresponding to the n-th layer from the bottom is updated, update a layer-by-layer image of the n-th layer from the bottom.

6. The container image integration system according to claim 4, wherein the processor is configured to execute the instruction to read a layer-by-layer image created for a component that matches a name and version information from the memory and copy a file from the layer-by-layer image on the basis of integrated definition information that defines names and version information of the components of the plurality of layers.

7. A container image integration method comprising:
integrating a plurality of layer-by-layer images that are container images of components of a plurality of layers created for the plurality of layers of an integrated image configured by the plurality of layers that is a container image to be created to create the integrated image by copying files from the plurality of layer-by-layer images to the integrated image on the basis of the plurality of layer-by-layer images and configuration definition information of the plurality of layer-by-layer images.

8. A non-transitory computer-readable recording medium that stores a program causing a computer to execute a process of integrating a plurality of layer-by-layer images that are container images of components of a plurality of layers created for the plurality of layers of an integrated image configured by the plurality of layers that is a container image to be created to create the integrated image by copying files from the plurality of layer-by-layer images to the integrated image on the basis of the plurality of layer-by-layer images and configuration definition information of the plurality of layer-by-layer images.
